(19) United States
(12) Patent Application Publication
(10) Pub. No.: US 2025/0182231 A1
(43) Pub. Date: Jun. 5, 2025

(54) SYSTEM FOR ACTIVE PARTICIPATION AND IMPROVEMENT OF SCHOOL SECURITY

(71) Applicant: MOTOROLA SOLUTIONS, INC., CHICAGO, IL (US)

(72) Inventor: JOHN A. KROL, SCHAUMBURG, IL (US)

(21) Appl. No.: 18/529,677

(22) Filed: Dec. 5, 2023

(51) Int. Cl. G06Q 50/26; G06F 9/451; G08B 13/196; H04N 7/18

(52) U.S. Cl. CPC G06Q 50/265; G06F 9/451; G08B 13/19652; H04N 7/181

(57) ABSTRACT

A device, system and method to log a communication device into services using a device identifier is provided. An identity management (IM) computing device receives, from a certificate authority, a first digital certificate, and further receives from a given communication device, a second digital certificate and a device identifier associated with the given communication device. The IM computing device successfully validates the second digital certificate using the first digital certificate, obtains a user identifier associated with the device identifier, and issues, to the given communication device, one or more tokens that include the user identifier, the one or more tokens enabling the given communication device to log into one or more services using the user identifier.

### BACKGROUND OF THE INVENTION

Maintaining security of a location may require multiple actors and devices to ensure adherence and support of a security protocol for the location. Each type of actor within the location can have different responsibilities and capabilities with respect to performing security or remediation actions under the security protocol. In some situations, a user interface may encourage actor actions that comply with the security protocol and teach skills that improve the security of the location.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a user interface, as implemented at a computing device, that illustrates a security situation for a zone of a building, in accordance with some examples.

FIG. 2 illustrates a block diagram of a communication device in accordance with some examples.

FIG. 3 is a block diagram of a system configured to detect and analyze a security situation of a building and to prompt users to comply with a security protocol for the building, in accordance with some examples.

FIG. 4 depicts a user interface, as implemented at a computing device, that illustrates security information corresponding to a location, in accordance with some examples.

FIG. 5 depicts historical security scores assigned to various zones within a building based on a security protocol, in accordance with some examples.

FIG. 6 is a system diagram illustrating a system for operating an electronic digital assistant, in accordance with some examples.

FIG. 7 is a device diagram showing a device structure of an electronic ssome examples.

FIG. 8 is a flowchart of a method to improve security of a location, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

It may be challenging to ensure compliance with security policies and protocols for a location or a building, such as a school building. As a result, insecure and dangerous situations may result for the building. For example, violations of security protocols may directly or indirectly result in inadequate responses to acts of violence at the school building. As such, it may be desirable to improve compliance with security policies to improve the security of inhabitants or users of the school building or other locations. In particular, it may be desirable to improve active participation and proactive and beneficial security actions for various actors within the school building, such as students, teachers, facility staff, administration, visitors, and/or the like. As such, a culture of continuous improvement and compliance of security policies can be achieved.

The present disclosure provides a technical solution to the particular technical challenges of a computerized system for achieving physical security of a building or location. In particular, the present disclosure provides an improvement to the functioning of a computer by improving the speed and efficiency of sensor and computing device communications. As described herein, the integration of user actions and sensor output data results in features that enable the assessment of the sensor installation location and operation. For example, based on determined security scores, it may be determined whether to change the location or operating parameters of the sensor to improve building security. Operating parameters could be a camera or sensor's field of view, capture rate, resolution, focal, aperture, and/or the like. Moreover, the integration of sensor and computer system results in integration of the computing system into a practical application that improves physical security by prompting users to take ameliorative security action and improving the functioning of sensors that capture security data.

According to one embodiment of the present disclosure, a computer-implemented method for improvement of school security is provided. The method includes determining a layout of a building for a user interface implemented by a computing device. The method also includes identifying a security policy for a zone of the building for a period of time. The method also includes generating, via the user interface, an indication of a violation of the security policy. The method also includes determining, based on an identity of the user, a remediation action for a user to clear the violation of the security policy. The method includes calculating, based on the security policy and an output of a sensor located at the zone of the building, a security score for the zone of the building.

In accordance with one example embodiment of the present disclosure, a system is provided including a processor configured to perform a method for improvement of school security. The method includes determining a layout of the zone of the building for output to a user interface. The method also includes identifying a security policy for a zone of the building for a period of time. The method also includes generating, via the user interface, an indication of a violation of the security policy. The method also includes determining a remediation action that an identity of a user indicates the user is permitted to perform for the zone of the building. The method also includes determining a reward based on a verification via the sensed data from the sensor that the user performed the remediation action to clear the violation of the security policy. The method includes calculating, based on the reward and the sensed data, a security score for the zone of the building.

In accordance with one example embodiment of the present disclosure, a computing device including a processor and a computer-readable storage medium is provided including instructions (e.g., stored sequences of instructions) that, when executed by the processor, cause the processor to perform a method for improvement of school security. The method includes determining a layout of a building for a user interface implemented by a computing device. The method also includes identifying a security policy for a zone of the building for a period of time. The method also includes generating, via the user interface, an indication of a violation of the security policy. The method also includes determining, based on a skill attribute of a user and an output of a sensor located at the zone of the building, a remediation action for the user to clear the violation of the security policy. The method includes calculating, according to the remediation action, a security score for the zone of the building.

Each of the above-mentioned embodiments will be discussed in more detail below, starting with example system and device architectures of the system in which the embodiments may be practiced, followed by an illustration of processing blocks for achieving an improved technical method, device, and system for improvement of building or school security.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

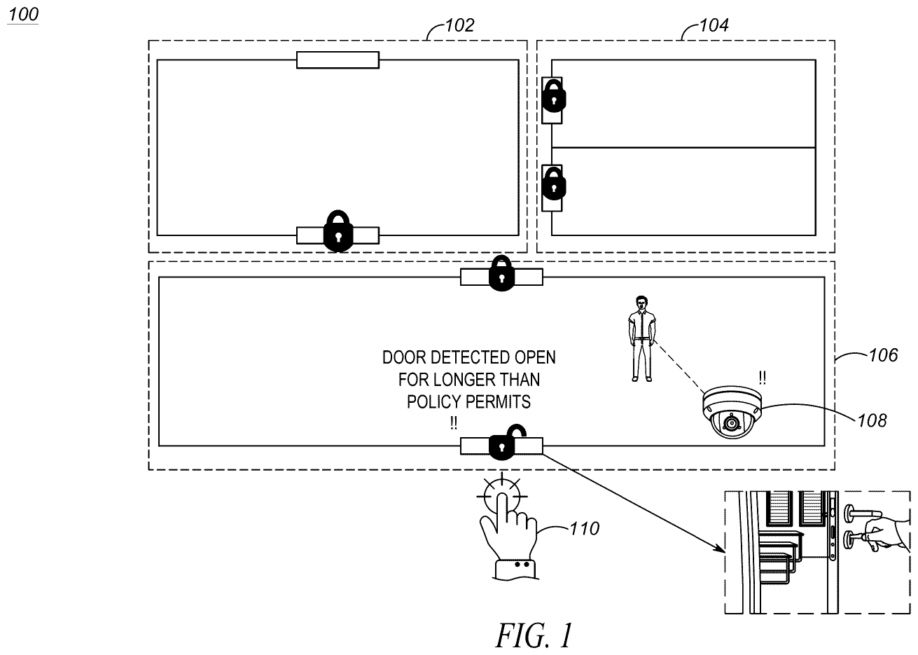

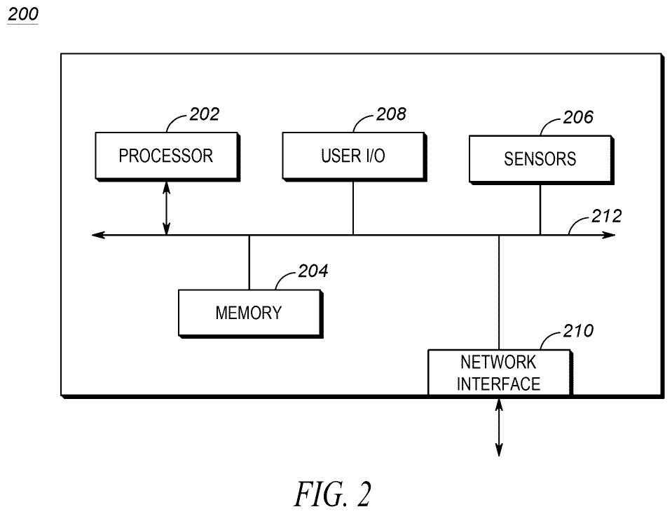

FIG. 1 depicts a user interface 100, as implemented at a computing device, that illustrates a security situation for a zone of a building, in accordance with some examples. The computing device may be similar as one described in FIG. 2 or any other suitable computing device, for example. The user interface 100 can contain a dashboard 102 that corresponds to a particular location such as a building, school, facility, or the like, for example. The dashboard 102 can be organized according to a mapping or a layout of the particular location that comprises distinct areas and/or subareas such as zones. The dashboard 102 may be organized according to a particular color scheme, such as being color coded according to red, green, and yellow similar to a traffic light color coding, for example. Accordingly, the color red may indicate that a remediation action for a user to clear the violation of a security protocol or policy is required, the color yellow may indicate a warning or a decaying security status, and the green may indicate an all clear (e.g., there is no current violation of the security protocol). As depicted in the user interface 100, a part of the dashboard 102 corresponding to a particular zone within the particular location (e.g., building) can be labeled with any of the colors of the color coding scheme.

For example, zone A 102 of the building may be labeled with a green color code to indicate an acceptable or healthy security score. As an example, zone A 102 may be locked by a specific type of user such as a facility personnel. Upon the locked status being verified by a sensor 108, zone A 102 can be assigned a security score that is classified as green on dashboard 100 such that the user interface 100 depicts zone A 102 as not currently violating the security policy. The sensor 108 may be a body worn camera, video camera, audio, radio, weapons status sensor or door sensor, and/or the like. The sensor 108 can be used to output sensed data about various areas within the building. The sensor 108 may be configured to determine, analyze, or evaluate a characteristic of a security situation within a corresponding area of the building (or for the entire building or location). As an example, the sensor 108 can indicate that a door of zone C 106 has been detected as open for longer than permitted by the applicable security policy. As such, the dashboard 102 may include visual indications of unlocked or locked padlock icons (e.g., open and closed padlock), respectively, to indicate that zone A 102 is locked and zone C 106 is locked.

The visual indications can also include the color coding described herein. For example, the color green can be assigned to zone A 102 to indicate compliance with the security policy while the color red can be assigned to zone C 106 to indicate a violation of the security policy based on the open door remain open for too long. Assigned colors may change or decay such as over a period of times. For example, a green color indicating a high security score and/or compliance with security policy can degrade to another less compliant color such as yellow or red which can indicate a security policy violation or a progressively decreasing security score (e.g., decay). As such, a quantitative value of an assigned security score can be used to assign a color according to the color coding. For example, a high security score can be assigned green, a medium security score can be assigned yellow, and a low security score can be assigned red. A given security score can decay over time for various reasons specified by the security policy. As an example, the security score can decay as a result of a degrading security situation such as people or other objects being present in a zone of the building that are not permitted, an issue with access control (e.g., broken padlock, broken equipment, etc.), a neglected maintenance issue, a duration of time since a prior security check in, an improper action (e.g., a user not registering their presence as required by the security policy), and/or the like.

Accordingly, the zone B 104 of the dashboard 102 includes a subarea (e.g., a room of a school) in which a previously assigned green security score has decayed to a yellow security score. This color change may reflect that no personnel has checked the subarea for a time that surpasses what is permitted by the security policy. In this way, the color change can indicate to a certain type of user that they need to take some type of remediation action to address or clear the security situation. For example, the user identity can be an administrative staff that is responsible for securing the lunch room of the school and can be prompted by their computing device that renders the user interface 100 to perform the type of remediation action. In some situations such as if no action has been taken within a threshold period of time, the color can begin flashing. Thus, the zone B 104 can have additional visual indicators as more time elapses between when the administrative staff should have taken the remediation action to indicate the urgency of the required action.

A particular user of the user interface 100 can use the computing device hosting the user interface 100 to manage their security associated responsibilities for the building. The user can interact with graphical user interface (GUI) elements of the user interface 100 to determine, evaluate, analyze, receive, send, and otherwise manipulate security information for the building. The user may use a user controllable cursor 110 or other interaction element to view or interact with security information. As an example, tapping a violation such as the unlocked padlock graphical element of zone C 106 can be used to retrieve more information or take some related action for the security situation. As such, because the unlocked padlock indicates that a corresponding door was detected open for longer than the security policy permits, tapping the violation with the cursor 110 may bring up video of when the violation occurred, so it is known who caused the violation. Other examples of interactive violation detection are also contemplated by the present disclosure.

In general, security situations within the building can be determined, analyzed, and verified by the sensor 108. In this way, the user interface 100 advantageously can indicate security status through dynamically updated security scores, compliance or violations of the security protocol, security ameliorative actions, and security information based on various locations and the particular identity of the user of the user interface 100. For example, when the building is a school, the identity of the users may influence how the dashboard 102 is organized, including the type of skill tree that is applicable, the types of security actions required, the type of remediation actions available, and the characteristics of the security scores assigned to the various zones of the school according to the identity of the user. For example, the user identity can be a student, teacher, administration, facility staff, visitor, parent, and/or the like. The integrated sensor 108, user interface 100, and security system advantageously may improve school/building security. As an example, the sensor 108 may detect a person residing in a room of the school outside of open hours specified by the security policy. The sensor 108 can also detect other obstructions or violations of the security policy such as an obstruction to properly locking the room's door, the door detected as being open longer than permitted by the security policy, and/or the like.

Accordingly, users can view the dashboard 102 of the user interface 100 to determine security issues that require their attention and/or actions that the users need to take. As an example, the dashboard 102 may be part of a cloud native emergency coordination platform. A general example hardware structure for the various components of the user interface 100 is described with respect to FIG. 2, and some specific functionality of the various components of the hardware structure is next described. For example, the hardware structure of FIG. 2 may be used to implement, render, or host the user interface 100.

FIG. 2 illustrates a block diagram of a computer device 200 in accordance with some embodiments. In some embodiments, the computer device 200 may be a personal device, such as a UE, or a network device, or other equipment used in the network environment). The computer device 200 may include a physical device and/or a virtual device, such as a server running one or more virtual network functions (VNFs) of a network. In various examples, the computer device 200 may be a specialized computer, a personal or laptop computer (PC), a tablet PC, a mobile telephone, a smartphone, a network router, switch or bridge, or any machine capable of executing instructions (sequential or otherwise) that specify actions to be taken by that machine. In some embodiments, the computer device 200 may be an internet-of-things (IoT) or a narrowband IoT (NB-IoT) device or other device embedded within other, non-communication-based devices such as appliances or vehicles. The computer device 200 may render the user interface 100 (or similar UIs) for providing a security dashboard application that manages and improves building/school security.

The computer device 200 may include various components connected by a bus 212. The computer device 200 may include a hardware processor 202 such as one or more central processing units (CPUs) or other processing circuitry able to provide any of the functionality described herein when running instructions. The processor 202 may be connected to a memory 204 may include a non-transitory machine-readable medium on which is stored one or more sets of instructions. The memory 204 may include one or more of static or dynamic storage, or removable or non-removable storage, for example. A machine-readable medium may include any medium that is capable of storing, encoding, or carrying instructions for execution by the processor 202, such as solid-state memories, magnetic media, and optical media. The machine-readable medium may include, for example, Electrically Programmable Read-Only Memory (EPROM), Random Access Memory (RAM), or flash memory.

The instructions may enable the computer device 200 to operate in any manner thus programmed, such as the functionality described specifically herein, when the processor 202 executes the instructions. The machine-readable medium may be stored as a single medium or in multiple media, in a centralized or distributed manner. In some embodiments, instructions may further be transmitted or received over a communications network via a network interface 210 utilizing any one of a number of transfer protocols (e.g., frame relay, internet protocol (IP), transmission control protocol (TCP), user datagram protocol (UDP), hypertext transfer protocol (HTTP), etc.).

The network interface 210 may thus enable the computer device 200 to communicate data and control information (e.g., security information) with other devices via wired or wireless communication. The network interface 210 may include electronic components such as a transceiver that enables serial or parallel communication. The wireless connections may use one or more protocols, including Institute of Electrical and Electronics Engineers (IEEE) Wi-Fi 802.11, Long Term Evolution (LTE)/4G, 5G, Universal Mobile Telecommunications System (UMTS), or peer-to-peer (P2P), for example, or short-range protocols such as Bluetooth, Zigbee, or near field communication (NFC). Wireless communication may occur in one or more bands, such as the 800-900 MHz range, 1.8-1.9 GHz range, 2.3-2.4 GHz range, 60 GHz range, and others, including infrared (IR) communications. Example communication networks to which computer device 200 may be connected via network interface 210 may include a local area network (LAN), a wide area network (WAN), a packet data network (e.g., the Internet), mobile telephone networks (e.g., cellular networks), and wireless data networks. Computer device 200 may be connected to the networks via one or more wired connectors, such as a universal serial bus (USB), and/or one or more wireless connections, and physical jacks (e.g., Ethernet, coaxial, or phone jacks) or antennas.

The computer device 200 may further include one or more sensors 206, such as one or more of an accelerometer, a gyroscope, a global positioning system (GPS) sensor, a thermometer, a magnetometer, a barometer, a pedometer, a proximity sensor, a door sensor, an ambient light sensor, among others. The sensors 206 may include some, all, or none of one or more of the types of sensors above (although other types of sensors may also be present), as well as one or more sensors of each type. The sensors 206 can be configured to output security information at a zone of a building, such as to indicate the presence of unauthorized individuals at certain times, that a door or window is improperly left open, and/or the like. The sensors 206 may be used in conjunction with one or more user input/output (I/O) devices 208 to indicate security condition information at a user interface dashboard such as that described in FIG. 1. The user interface can indicate whether the sensors 206 are malfunctioning, for example. The user I/O devices 208 may include one or more of a display (e.g., a touch screen display of a mobile computing device), a camera, a speaker, a keyboard, a microphone, a mouse (or other navigation device), or a fingerprint scanner, among others. The user I/O devices 208 may include some, all, or none of one or more of the types of I/O devices above (although other types of I/O devices may also be present), as well as one or more I/O devices of each type.

The computer device 200 may include different specific elements depending on the particular device. For example, although not shown, in some embodiments, computer device 200 may include a front end that incorporates a millimeter and sub-millimeter wave radio front end module integrated circuit (RFIC) connected to the same or different antennae. The RFICs may include processing circuitry that implements processing of signals for the desired protocol (e.g., medium access control (MAC), radio link control (RLC), packet data convergence protocol (PDCP), radio resource control (RRC) and non-access stratum (NAS) functionality) using one or more processing cores to execute instructions and one or more memory structures to store program and data information. The RFICs may further include digital baseband circuitry, which may implement physical layer functionality (such as hybrid automatic repeat request (HARQ) functionality and encoding/decoding, among others), transmit and receive circuitry (which may contain digital-to-analog and analog-dto-digital converters, up/down frequency conversion circuitry, filters, and amplifiers, among others), and RF circuitry with one or more parallel RF chains for transmit/receive functionality (which may contain filters, amplifiers, phase shifters, up/down frequency conversion circuitry, and power combining and dividing circuitry, among others), as well as control circuitry to control the other RFIC circuitry.

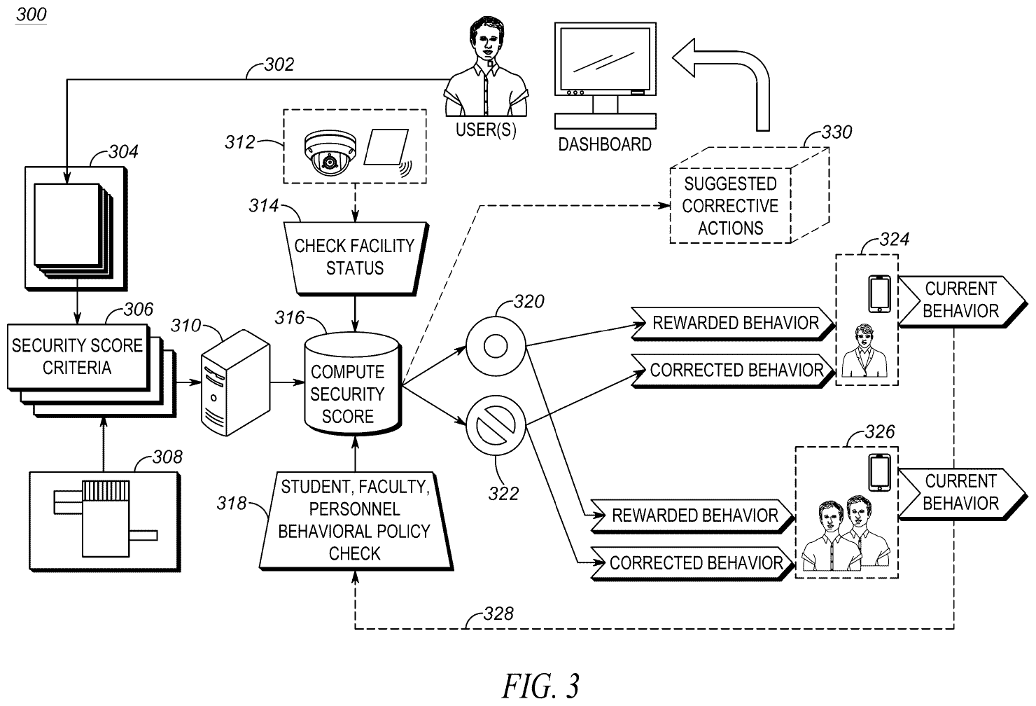

FIG. 3 is a block diagram 300 of a system configured to detect and analyze a security situation of a building and to prompt users to comply with a security protocol for the building, in accordance with some examples. As depicted in the block diagram 300, the system includes a particular user of a security dashboard, such as one similar to that described in reference to the user interface 100 of FIG. 1. When the system is applied to enhance a security situation for a location such as a school building, the user may be a student, faculty member, security personnel member, visitor, parent/guardian, or other entity that may enter the school building. Depending on the specific identity of the user, a different type of user interface 100 may be located on a computing device of the specific user. The user at step 302 may manipulate or otherwise control a security protocol or policy for the building. As an example, the specific user may be school building facility personnel or administration controlling the security dashboard at a computing device console. The facility or administrative user consequently may be permitted to update the security policy, facility information (e.g., school room layout), or other security information.

The security policy information may be stored in the form of computer readable or executable rules (e.g., software) such as in the security policy database 304. The rules from the security policy database 304 may be implemented by a computing system that manages security for the school building, such as via sensors, processors, and other computational devices capable of applying the security policy rules. Based on the rules of the security policy database 304, security score criteria 306 can be determined, evaluated, and/or modified such that the computing system can calculate security scores for each user and/or per zone of the school building. A physical or geographical mapping of the school building can be embodied and stored as building layout 308. For example, the map of the school building may be used as part of a facility management dashboard application (the security dashboard of FIG. 1 may be part of this dashboard application. As an example, the map provides a floorplan that visually indicates the various zones within the school building. Each zone within the school building can be assigned its own security score or a combination of zones can receive a single security score (e.g., classrooms of two different zones could be grouped together for assignment of a security score or the entire school building encompassing all zones could receive the single security score).

As discussed above, the rules of the security policy database 304 define security score criteria 306 that can be used by an electronic system (e.g., a computing device 310) of the computing system to compute security score(s) stored in the security score database 316. For example, the security score criteria 306 may define a threshold number of instances that the user checks in or clears security situations that require their attention. As an example, the user could be administrative personnel that is responsible for securing zones of the school building after school hours such that they receive a low score if they have only cleared 3 of 10 possible security situations requiring their attention, a medium score if they have checked in at 6 or less of the 10 possible, or a high score if the user has properly addressed 6 or more security situations of the 10 possible. As an example, the security score criteria 306 may define a security score component based on the number of devices that are functioning for the zone(s) of the school building that the user is responsible for during their patrol time. Specifically, the user could be administrative personnel that is responsible for ensuring that all sensors (e.g., cameras, door sensors) located within their zone(s) are functioning properly. The different security score components may all be stored as security data within the security score database 316.

As an example, the security score criteria may define a set number of points that should be deducted from the user's security score based on how many sensors are malfunctioning during their patrol time. Conversely, a set number of points could be added to the user's security score based on how many sensors are functioning properly. In general, the security score criteria 306 may define various user actions or situations that result in a specific quantity of points being added to or deducted from the user's dynamic security score (e.g., running tab of points that can increase or decrease according to how well the user is complying with the security policy as represented by the security score criteria 306). The security score can be color coded such as, for example, the color red may indicate that a remediation action for the user to clear the violation of a security protocol or policy is required, the color yellow may indicate a warning or a decaying security status, and the green may indicate an all clear (e.g., there is no current violation of the security protocol). The security score may have different components, each of which can be color coded individually. For example, there could be a security score for an aspect of securing various rooms within the corresponding zone (e.g., no one unauthorized is present within the various rooms at the time they are there) and another aspect of the score for securing devices (e.g., ensuring padlocks work). Alternatively, there could be separate security scores for the different aspects, such as individual security scores for different security skills.

Different security situations can trigger updates relative to the security score database 316. That is, when a characteristic of a security situation changes (e.g., time of day, presence of a new entity, device status), the security score of that zone or location changes based on the characteristic and/or the response to the characteristic. Updates can be triggered based on the characteristic indicating that the security status of a subject zone of the school building has changed. For example, a sensor suite 312 can be used by the computing device 310 to determine that the change in the security situation characteristic has occurred. The sensor suite 312 may include various sensors such as cameras (e.g., body worn camera, video camera), radio sensors, infrared door sensors, noise/audio sensors, microphonic sensors, and/or the like. The sensor suite 312 may be configured to detect a security status or characteristic of various zones within the building. The sensor suite 312 can output sensed data about the subject zone to the computing device 310 so as to trigger a check facility status action at step 314. The check facility action can include evaluating sensed data about whether pertinent sensors of the sensor suite 312 are functional (e.g., replace sensor battery), whether doors or windows are sensed to be secure and shut, whether unauthorized people or other entities are improperly present at various zones within the building, whether locks are functional, whether students are properly chaperoned, or other action items, for example.

The security actions being evaluated or checked at step 314 may depend on the subject sensor as well as the identity of the actor using the security dashboard that is subject to the check facility action. For example, if the user is a teacher, the check facility action can be whether the teacher's classroom and students within in are secure (e.g., students all present and doors/windows are secure). If the user is administrative staff (e.g., a principal), the check facility action may be whether student complaints about security are sensed to be addressed (e.g., tripping hazard within a classroom). As illustrated in the block diagram 300 of FIG. 3, the check facility status step at 314 triggers a computation or updated computation of the security score. The computed security score may be a personal score calculated for the user based on their corresponding user identity and/or skill tree or the computed security score may be an overall facility score for the building. As described in more detail herein, the computation of the security score(s) stored in the security score database 316 can include a determination by the computing device 310 of whether the user's actions or behavior comply or adhere to the security policy at step 320 or whether they violate the security policy at step 322.

When user behavior or actions are determined at step 320 to comply with the security policy, such behavior may be labeled as rewarded behavior and result in an increase to the current security score stored in the security score database 316. Conversely, when user behavior or actions are determined at step 322 to violate the security policy, such behavior may be labeled as rewarded behavior and result in an decrease to the current security score stored in the security score database 316. Such behavior can be determined as rewarded or corrected based on the particular identity of the user. For example, the user may be on scene facility personnel such that the personnel user could perform rewarded behavior by ensuring no dangerous items (e.g., sharp objects) are present in a specific zone of the school building or could be determined to need corrected behavior based on failing to replace a door sensor battery. As an example, the user may be a teacher or faculty member who may be rewarded for ensuring all students in their classroom in the school building are properly chaperoned for an after hours (e.g., after 5 pm) activity or may be determined to need corrected behavior based on students in their classroom possessing prohibited items or being frequently late to scheduled events/activities.

The rewarded and corrected behavior that are inputs to the stored security score in the security score database 316 may be calculated, monitored, and interacted with via a companion app depending on the particular identity of the user. For example, the companion app may include a dashboard similar to the dashboard depicted in FIG. 1. Information such as skill trees can be personalized to the identity of the user on the companion app. As an example, the companion app may be personnel companion app 324 or a student/faculty companion app 326, etc. Based on the detected user behaviors and/or associated security score(s), a student, faculty, and/or personnel behavioral policy check may be performed at step 318. This policy check can include assessing what corrective behavior have been performed or need to be implemented as well as positive feedback for behaviors that have been or should be rewarded. The policy check at step 318 may also result in adjustments to the security policy. As an example, the security policy could be adjusted to better accommodate students with disabilities, such as by adjusting a penalization in security score for students in wheelchairs who are frequently late to extracurricular activities. As such, the policy check at step 318 could result in certain exceptions or other adjustments to the security policy to better accommodate those students with physical or mental disabilities. The security score calculated for the security score database 316 can be adjusted according to the policy check at step 318.

Furthermore, the stored security score can trigger prompts for suggested corrective actions at step 330. The prompts may be received on the user's companion app or dashboard such that the user is encouraged to address compliance problems with the security policy. Such problems may include facility issues or behavioral problems. The suggested corrective actions at step 330 can be triggered as notifications to the user, such as visual indicators (e.g., flashing colors on the corresponding user interface) on the dashboard of the companion app. For example, if the user is a security guard, the security guard may be prompted on their companion app to check on a historically troublesome zone of the school building that they are responsible for securing. For example, the troublesome zone may have a history of unauthorized individuals being in the zone after hours, a door that should be locked being unlocked instead, a security camera in the zone malfunctioning etc. Such issues that violate the security policy may be flagged as corrective actions at step 330 for the corresponding responsible user. The calculated security score and suggested corrective actions may be used by the user to evaluate their own personal security performance such as to improve their security check ins and actions, for example.

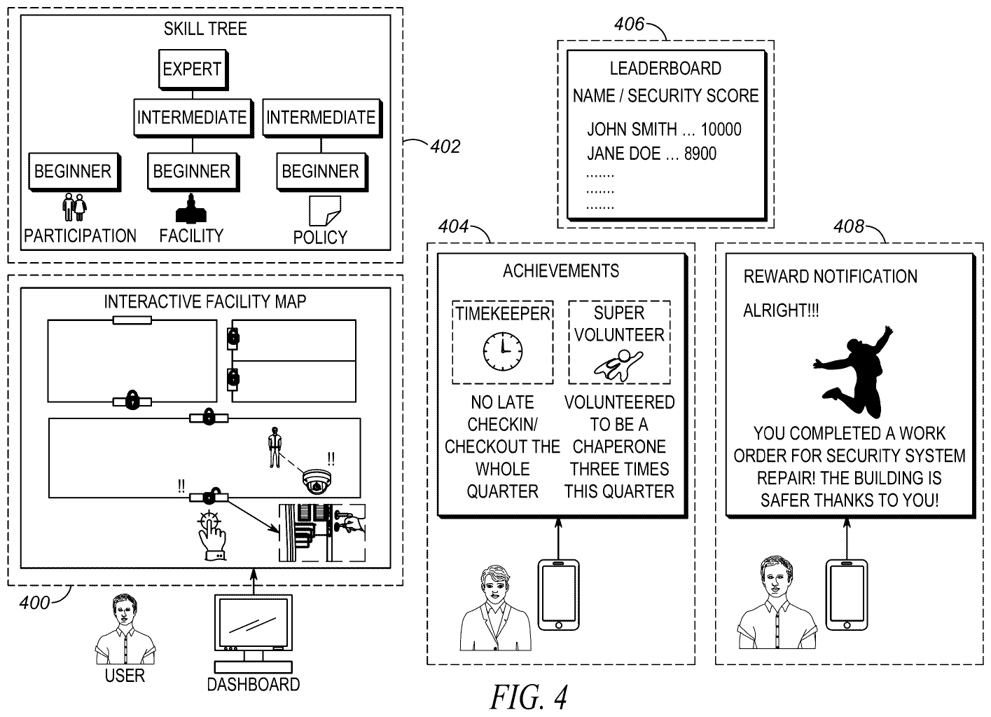

FIG. 4 depicts a user interface, as implemented at a computing device, that illustrates security information corresponding to a location, in accordance with some examples. As an example, the user interface of FIG. 4 could be accessible via the dashboard 102 of the user interface 100 on a user device described in FIG. 1. As depicted in FIG. 4, the interface of FIG. 4 includes an interactive facility map element 400, a skill tree element 402, an achievements element 404, a leaderboard element 406, and a reward element 408. These elements may be GUI elements that users may graphically interact with using a user interaction method on their user devices (e.g., touchscreen, computer cursor, etc.) The interactive facility map 400 may be similar to the screen of the dashboard 102 shown in FIG. 1, which visually depicts a security situation for a zone of a facility building. That is, the interactive facility map 400 indicates compliance or violations of a guiding security policy or protocol for various zones of the facility. The user of the user device can interact with the facility map 400 to determine zones that require user action or attention as well as to analyze or evaluate the current, historical, or future security situation for various security zones depicted within the facility map 400.

The skill tree element 402 can indicate the skills associated with varying skill levels in terms of security awareness or capability of various users. For example, users can use a UI cursor to hover over different skill trees for different actors on the skill tree such that the composition of the corresponding skill tree depends on the identity of the user/actor (e.g., student participant, facility employee, visitor). The range of varying levels can depend on which particular skill tree of the skill tree element 402 is selected, such that skill levels are assessed depending on the identity of the subject user. For example, if the identity of the user is security guard (e.g., facility staff), they could be assessed to be a beginner, intermediate, or expert for a responsiveness skill attribute depending on how many student complaints the security guard properly responded to. As an example, amount of responses by the security guard could be compared to a threshold number of five complaints per month (e.g., greater than 5 could result in an intermediate or expert status on the particular skill tree). As shown in FIG. 4, the skill tree for student participants can include a skill level of beginner, the skill tree for facility employees includes skill levels of beginner, intermediate, and expert while the skill tree for visitors who are unfamiliar with the policy can include skill levels includes beginner and intermediate.

More or less skill levels may be added or removed for various skill trees for different user identities as appropriate. The skill tree element 402 can be triggered to display on the interactive facility map 400 of the user device when the user is responding to security situations that require their attention (e.g., the facility's security policy requires some action or attention from the user according to their user identity). In this way, the user may use the skill tree element 402 to view and analyze their security preparedness and progress as well as determine their status in terms of their relevant skill tree and/or security score. For example, a security score numerical value can be assigned based on the user's security responses and actions according to their relevant skill tree. The leaderboard element 406 can show the users in the facility with the highest security score values. In this way, users can receive positive feedback and encouragement for having the highest security scores in the facility. The achievements element 404 may display security oriented achievements that the user has performed or attained for their security responsibilities.

In general, the achievements element 404 can highlight actions or behavior of the user that comply with the security policy or increase security preparedness for the facility generally. As an example, the user may be a visitor such as a chaperone in the facility such that they may receive the timekeeper and/or super volunteer achievements based on their historical performance, corresponding security score, or skill tree status. For example, the chaperone may not have had any students check in or check out late for an entire quarter in the academic calendar to receive the timekeeper achievement. For example, the chaperone may have volunteered to be a chaperone for student activities three times in the enter quarter which is greater than volunteering threshold and earns the chaperone the super volunteer achievement. As an example, the achievements element 404 can display an achievement for a student being proactive and reporting security situations in an area where cameras are not located, such as a bathroom within the relevant security zone or even display an achievement for students or other users following the security rules/policy.

Relatedly, the reward element 408 can include positive feedback, security score increases, and/or real world prizes (e.g., a gift card, bonus prize, service hours or qualification points, etc.) based on the user's security behavior constituting completion of a necessary security action. As an example, the user can receive a set quantity of security points for their security score and/or skill tree progress based on fixing a broken lock which can increase the overall security of the facility (e.g., against a potential active shooter). As an example, the rewards element 408 can include a displayed notification and encouragement that the user completed a work order for security system. The rewards element 408 can include praise for the user on the dashboard/companion app of the user device for helping improve the facility's safety based on the user's completed security action (e.g., filling out a security report). The rewards element 408 can include encouraging or warning graphical elements such as shields (e.g., indicating positive security activity) or warnings or red flags (e.g., indicating violations or security situations that require attention) on the user interface. Some achievements of the achievements element 404 such as volunteering to be a chaperone or verifying all students participating in a musical extracurricular are present can unlock certain rewards of the rewards element 408. Rewards, achievements, and skill trees can be capped for certain activities/situations or in general for skill levels, as determined according to the security policy. Also, regular audits or security reviews can be rewarded via the rewards elements 408.

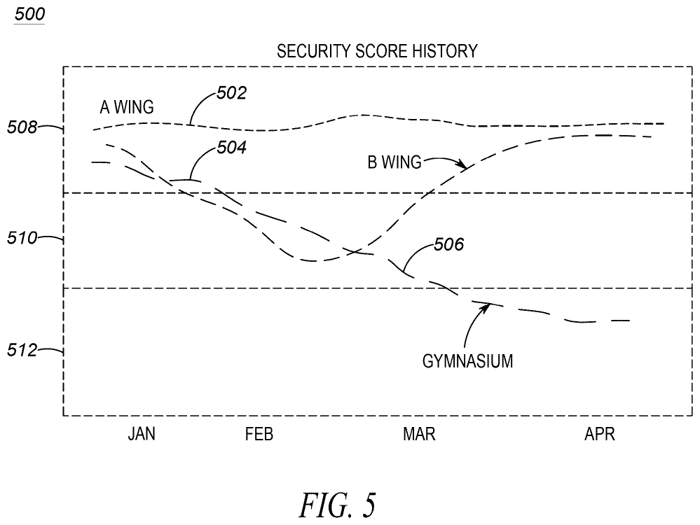

FIG. 5 is a graph 500 that depicts historical security scores assigned to various zones within a building based on a security protocol, in accordance with some examples. The graph 500 of historical security scores may be displayed on a facility management dashboard type of application, such as for a school building. The displayed historical security scores on the graph 500 may be based on various zones within the school building according to a school building map subject to one or more security protocols or policies. For example, the various zones may include an A wing, B wing, and gymnasium. As shown in FIG. 5, in the graph 500, the x axis represents time such as in months (e.g., January to April). The graph 500 of FIG. 5 also includes a y axis that represents the respective quantity calculated for each security score corresponding to the A wing, B wing, and gymnasium zones of the school building. In this way, the A wing line 502, B wing line 504, and gymnasium line 506, representing the calculated values of their respective security. The indicated security scores can be assigned to a particular user of a user device executing the school building dashboard application and the assigned scores can depend on the identity of the particular user as well as their assigned security tasks, skill tree, and security performance.

Additionally or alternatively, the A wing line 502, B wing line 504, and gymnasium line 506 could represent aggregated security scores for all users located in or responsible for a particular corresponding zone of the school building. In this way, it may be easier to visualize the determined security scores over time including how the security scores increased or decreased, such as over the January to April months indicated in the graph 500. The security scores on the graph 500 can be used for intervening action. For example, the administration of the school building may start additional security training in early February due to the decreasing security scores of the B wing as shown on the B wing line 504 or commence an investigation for why the gymnasium security scores are so low and constantly decreasing as shown on the gymnasium line 506. The security scores can also be used to assess the school building's overall security policy, such as building risks and what zones are in compliance or violation of the security policy. As discussed above, security situations and scores can be determined, calculated, and analyzed based on output of sensors that output sensed security data about a zone of a building (e.g., whether an unauthorized person is present, whether a lock is faulty, whether a dangerous condition exists).

In some situations, the building's overall security policy may be adjusted due to undesirable results, which can also be assessed via graphs such as the graph 500. For example, the understanding of security scores over time for various zones in the school building may be used to determine or adjustment of placement of sensors such as cameras or metal detectors. As such, the present disclosure provides a practical application for improving security computer systems. The computing system implementing the security dashboard application is integrated into a practical application that uses calculated security scores and detected/analyzed user actions and behavior to improve the operation of sensors. As an example, depending on calculated security scores for zones of the school building, sensors may be moved from one zone to another, may capture data at different frame rates or other operating characteristics, may have different point of views adjusted, may have different wake/sleep cycles, may be repaired, and/or the like. Additionally or alternatively, sensors may be installed or removed based on security information generated by the security computing system. In general, operation of the sensors and/or computing system may be adjusted based on security information analyzed, generated, or evaluated by the security computing system, which improves the technological speed, operation, and efficiency of the security computing system. For example, sensor operating parameters (e.g., camera or sensor's field of view, capture rate, resolution, focal, aperture) can beneficially be improved based on the security information.

In some situations, cameras/sensors may be prohibited from being located in certain places such as bathrooms. Graphs such as the graph 500 may be used to inform placement of sensors in view of varying security rules, zones, and environments. For example, the graph 500 can inform placing or changing the location of cameras so that they are not obstructed or so that their field of view is improved. Additionally or alternatively, the security policy can be adjusted for certain types or identities of users. As an example, students with disabilities may require certain accommodations to comply with the overall security policy. For example, the students with disabilities may trigger what should essentially be considered false reports. For example, a student in a wheelchair may frequently violate a security rule requiring check ins at a certain interval for a particular zone. The student may frequently be unable to check in on time, but accommodations for the student being in a wheelchair or other situation should be made as adjustments to the security policy which can be informed by the graph 500 or similar data visualization methods. The security policy can also be adjusted based on other characteristics such as the age of students and/or the like.

In general, security data generated by the security dashboard application may be used to assess the viability of one or more of the security protocols or policies as well as to assess false alarms. False alarms include excessive security alerts or repeated suspicious activity (e.g., a student constantly finds and reports broken stuff), for example. That is, the student constantly reporting broken items for security score points may suggest that something improper is happening to game the system (e.g., maybe the student is encouraging someone to purposefully break the items so the student can receive points or credit for it). Alternatively, repeated reports of the same item breaking could also indicate that the security policy is ineffective because it is not deterring students from breaking the same item. The computing system implementing the security dashboard application can include a pattern recognition component to assess and adjust for such false alarms. For example, an excessive number of times that a same incident occurs can trigger an alarm or warning.

The computing system can also detect inadequate security protocols as indicated by the graph 500 such as based on the gymnasium line 506. For example, ameliorative action can include placement of additional sensors or additional security patrols for the gymnasium. In general, security policy making can be informed by data generated by the computing system and/or data visualizations such as the graph 500. That is, the security dashboard application may be used to audit compliance with the security protocol. For example, if a supervisor has multiple buildings or locations that they are responsible for, the supervisor may use the security dashboard application to compare security performance between different instances of the multiple buildings or locations. That is, the supervisor can compare various facilities comprising a school district so as to avoid a “one size fits all” policy.

The security scores indicated by the graph 500 can also have visual indications or categorization such as the color coding discussed above. As an example, the color red may indicate that a remediation action for a user to clear the violation of a security protocol or policy is required, the color yellow may indicate a warning or a decaying security status, and the green may indicate an all clear (e.g., there is no current violation of the security protocol). Accordingly, the green zone 508 may denote security scores that are categorized as in an all clear zone. The yellow zone 510 may denote security scores that are categorized as in a warning zone. The red zone 512 may denote security scores that are categorized as in a remediation action required zone. For example, the red zone 512 can cause flashing visual indicators to display on corresponding displays of security dashboard user interfaces to prompt relevant users to take responsive security action.

Remediation actions that can be taken may depend on an identity of the user. For example, if the user is a student that notices a broken lock or glass, the student may need to call another user such as facilities manager to fix the broken lock or glass. As such, the student user and facilities manager user may have different associated rewards, skill levels/trees, and achievements on their respective applications based on their different user identities. The graph 500 can also be used to trigger additional training for users in zones categorized as red such as micro trainings on their user interfaces or to encourage reporting of security problems or situations. The trainings can be tailored for the user identity of the relevant actor. In general, some elements of the security analysis, audits or other computer based aspects of the security computer system described herein can be implemented with machine learning or artificial intelligence algorithms or models.

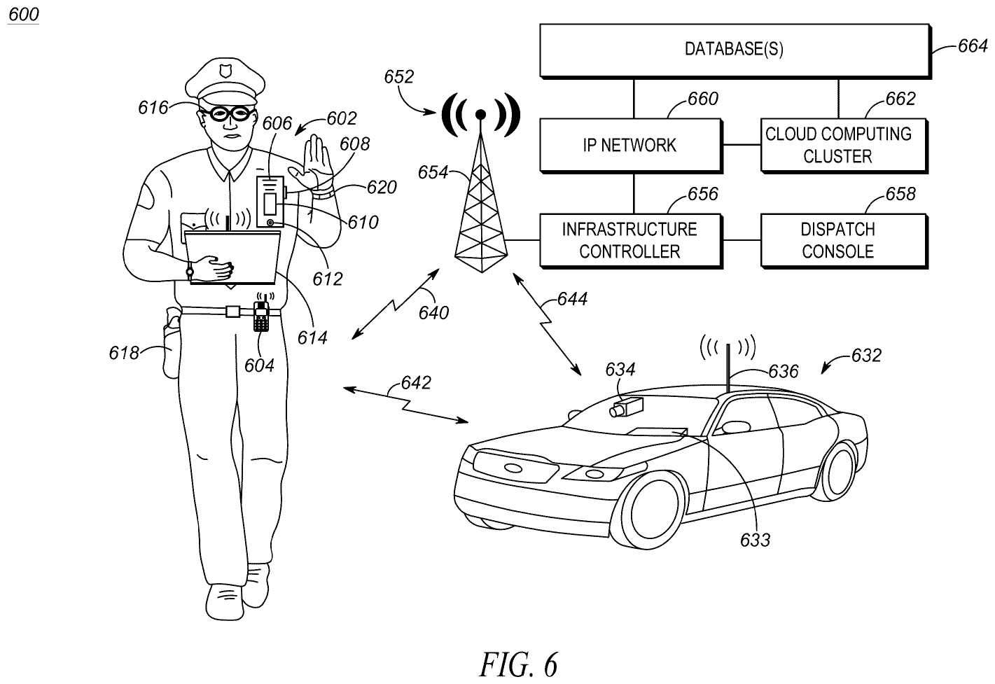

FIG. 6 depicts a communication system diagram illustrates a system 600 of devices including a first set of devices that a user 602 (illustrated in FIG. 6 as a first responder police officer) may wear, such as a primary battery-powered portable radio 604 used for narrowband and/or broadband direct-mode or infrastructure communications, a battery-powered radio speaker microphone (RSM) video capture device 606, a laptop 614 having an integrated video camera and used for data applications such as incident support applications, smart glasses 616 (e.g., which may be virtual reality, augmented reality, or mixed reality glasses), sensor-enabled holster 618, and/or biometric sensor wristband 620. The system 600 can be part of a computing system described herein for building or locational security. Although FIG. 6 illustrates only a single user 602 with a respective first set of devices, in other embodiments, the single user 602 may include additional sets of same or similar devices, and additional users may be present with respective additional sets of same or similar devices (wherein the single user 602 and the additional users may form a talkgroup of related users).

The system 600 may also include a vehicle 632 associated with the user 602 having an integrated mobile communication device 633, an associated vehicular video camera 634, and a coupled vehicular transceiver 636. Although FIG. 6 illustrates only a single vehicle 632 with a single mobile communication device 633, respective single vehicular video camera 634 and/or microphone 135, single coupled vehicular transceiver 636, and single speaker 137, in other embodiments, the vehicle 632 may include additional same or similar mobile communication devices, video cameras, microphones, speakers, and/or transceivers, and additional vehicles may be present with respective additional sets of mobile communication devices, video cameras, speakers, microphones, and/or transceivers.

Each of the portable radio 604, RSM video capture device 606, laptop 614, and vehicular mobile communication device 633 may be capable of directly wirelessly communicating via direct-mode wireless link(s) 642, and/or may be capable of wirelessly communicating via a wireless infrastructure radio access network (RAN) 652 over respective wireless link(s) 640, 644 and via corresponding transceiver circuits. These devices may be referred to as communication devices and are configured to receive inputs associated with the user 602 and/or provide outputs to the user 602 in addition to communicating information to and from other communication devices and the infrastructure RAN 652.

The portable radio 604, in particular, may be any communication device used for infrastructure RAN or direct-mode media (e.g., voice, audio, video, etc.) communication via a long-range wireless transmitter and/or transceiver that has a transmitter transmit range on the order of miles, e.g., 0.5-50 miles, or 3-20 miles (i.e., long-range in comparison to a short-range transmitter such as a Bluetooth, Zigbee, or NFC transmitter) with other communication devices and/or the infrastructure RAN 652. The long-range transmitter may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, the long range transmitter may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VOIP), an LTE Direct or LTE Device to Device, or a PTT over IP (PoIP) application may be implemented. In still further embodiments, the long range transmitter may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

In the example of FIG. 6, the portable radio 604 may form the hub of communication connectivity for the user 602, through which other accessory devices, such as a biometric sensor (for example, the biometric sensor wristband 620), an activity tracker, a weapon status sensor (for example, the sensor-enabled holster 618), a heads-up-display (for example, the smart glasses 616), the RSM video capture device 606, and/or the laptop 614 may communicatively couple.

In order to communicate with and exchange video, audio, and other media and communications with the RSM video capture device 606, laptop 614, and/or smart glasses 616, the portable radio 604 may contain one or more physical electronic ports (such as a USB port, an Ethernet port, an audio jack, etc.) for direct electronic coupling with the RSM video capture device 606, laptop 614, and/or smart glasses 616. In some embodiments, the portable radio 604 may contain a short-range transmitter (i.e., short-range in comparison to the long-range transmitter such as a LMR or broadband transmitter) and/or transceiver for wirelessly coupling with the RSM video capture device 606, laptop 614, and/or smart glasses 616. The short-range transmitter may be a Bluetooth, Zigbee, or NFC transmitter having a transmit range on the order of 0.01-600 meters, or 0.1-10 meters. In other embodiments, the RSM video capture device 606, the laptop 614, and/or the smart glasses 616 may contain their own long-range transceivers and may communicate with one another and/or with the infrastructure RAN 652 or vehicular transceiver 636 directly without passing through portable radio 604.

The RSM video capture device 606 provides voice functionality features similar to a traditional RSM, including one or more of acting as a remote microphone that is closer to the user's 602 mouth, providing a remote speaker allowing playback of audio closer to the user's 602 ear, and including a PTT switch or other type of PTT input. The voice and/or audio recorded at the remote microphone may be provided to the portable radio 604 for storage and/or analysis or for further transmission to other mobile communication devices or the infrastructure RAN 652, or may be directly transmitted by the RSM video capture device 606 to other communication devices or to the infrastructure RAN 652. The voice and/or audio played back at the remote speaker may be received from the portable radio 604 or received directly from one or more other communication devices or the infrastructure RAN 652. The RSM video capture device 606 may include a separate physical PTT switch 608 that functions, in cooperation with the portable radio 604 or on its own, to maintain the portable radio 604 and/or RSM video capture device 606 in a monitor only mode, and which switches the device(s) to a transmit-only mode (for half-duplex devices) or transmit and receive mode (for full-duplex devices) upon depression or activation of the PTT switch 608. The portable radio 604 and/or RSM video capture device 606 may form part of a group communications architecture that allows a single communication device to communicate with one or more group members (i.e., talkgroup members not shown in FIG. 6) associated with a particular group of devices at a same time.

Additional features may be provided at the RSM video capture device 606 as well. For example, a display screen 610 may be provided for displaying images, video, and/or text to the user 602 or to someone else. The display screen 610 may be, for example, a liquid crystal display (LCD) screen or an organic light emitting display (OLED) display screen. In some embodiments, a touch sensitive input interface may be incorporated into the display screen 610 as well, allowing the user 602 to interact with content provided on the display screen 610. A soft PTT input may also be provided, for example, via such a touch interface.

A video camera 612 may also be provided at the RSM video capture device 606, integrating an ability to capture images and/or video and store the captured image data (for further analysis) or transmit the captured image data as an image or video stream to the portable radio 604 and/or to other communication devices or to the infrastructure RAN 652 directly. The video camera 612 and RSM remote microphone may be used, for example, for capturing audio and/or video of a field-of-view associated with the user, perhaps including a suspect and the suspect's surroundings, storing the captured image and/or audio data for further analysis or transmitting the captured audio and/or video data as an audio and/or vide stream to the portable radio 604 and/or to other communication devices or to the infrastructure RAN 652 directly for further analysis. An RSM remote microphone of the RSM video capture device 606 may be an omni-directional or unidirectional microphone or array of omni-directional or unidirectional microphones that may be capable of identifying a direction from which a captured sound emanated.

In some embodiments, the RSM video capture device 606 may be replaced with a more limited body worn camera that may include the video camera 612 and/or microphone noted above for capturing audio and/or video, but may forego one or more of the features noted above that transform the body worn camera into a more full featured RSM, such as the separate physical PTT switch 608 and the display screen 610, remote microphone functionality for voice communications in cooperation with portable radio 604, and remote speaker.

The laptop 614, in particular, may be any wireless communication device used for infrastructure RAN or direct-mode media communication via a long-range or short-range wireless transmitter with other communication devices and/or the infrastructure RAN 652. The laptop 614 includes a display screen for displaying a user interface to an operating system and one or more applications running on the operating system, such as a broadband PTT communications application, a web browser application, a vehicle history database application, a workflow application, a forms or reporting tool application, an arrest record database application, an outstanding warrant database application, a mapping and/or navigation application, a health information database application, facility/building (e.g., school) security application, and/or other types of applications that may require user interaction to operate. The laptop 614 display screen may be, for example, an LCD screen or an OLED display screen. In some embodiments, a touch sensitive input interface may be incorporated into the display screen as well, allowing the user 602 to interact with content provided on the display screen. A soft PTT input may also be provided, for example, via such a touch interface.

Front and/or rear-facing video cameras may also be provided at the laptop 614, integrating an ability to capture video and/or audio of the user 602 and the user's 602 surroundings, perhaps including a field-of-view of the user 602 and/or a suspect (or potential suspect) and the suspect's surroundings, and store and/or otherwise process the captured video and/or audio for further analysis or transmit the captured video and/or audio as a video and/or audio stream to the portable radio 604, other communication devices, and/or the infrastructure RAN 652 for further analysis.

An in-ear or over-the ear earpiece or headphone 115 may be present for providing audio to the user in a private fashion that is not accessible to other users nearby the user 602. The earpiece or headphone 115 may be wiredly or wirelessly communicatively coupled to one or both of the RSM 606 and the portable radio 604, which may be configured to provide audio received from the RAN 652 and/or from other users to the user 602 based on a manual configuration of the RSM 606 or the portable radio 604, or based on some automatic routing mechanism at the one of the RSM 606 and the portable radio 604 that may route all audio to the earpiece or headphone 115 whenever it is detected as connected to the one of the RSM 606 and the portable radio 604, or may selectively route audio received at the one of the RSM 606 and the portable radio 604 to the earpiece or headphone 115 based on various contextual parameters, such as a content of the received audio, an identity of who sent the received audio, a covert status of the user 602, an incident status of the user 602, a determination of nearby users associated with the user 602, or some other contextual parameter.

The smart glasses 616 may include a digital imaging device, an electronic processor, a short-range and/or long-range transceiver device, and/or a projecting device. The smart glasses 616 may maintain a bi-directional connection with the portable radio 604 and provide an always-on or on-demand video feed pointed in a direction of the user's 602 gaze via the digital imaging device, and/or may provide a personal display via the projection device integrated into the smart glasses 616 for displaying information such as text, images, or video received from the portable radio 604 or directly from the infrastructure RAN 652. In some embodiments, the smart glasses 616 may include its own long-range transceiver and may communicate with other communication devices and/or with the infrastructure RAN 652 or vehicular transceiver 636 directly without passing through portable radio 604. In other embodiments, an additional user interface mechanism such as a touch interface or gesture detection mechanism may be provided at the smart glasses 616 that allows the user 602 to interact with the display elements displayed on the smart glasses 616 or projected into the user's 602 eyes, or to modify operation of the digital imaging device. In still other embodiments, a display and input interface at the portable radio 604 may be provided for interacting with smart glasses 616 content and modifying operation of the digital imaging device, among other possibilities.

The smart glasses 616 may provide a virtual reality interface in which a computer-simulated reality electronically replicates an environment with which the user 602 may interact. In some embodiments, the smart glasses 616 may provide an augmented reality interface in which a direct or indirect view of real-world environments in which the user is currently disposed are augmented (i.e., supplemented, by additional computer-generated sensory input such as sound, video, images, graphics, GPS data, or other information). In still other embodiments, the smart glasses 616 may provide a mixed reality interface in which electronically generated objects are inserted in a direct or indirect view of real-world environments in a manner such that they may co-exist and interact in real time with the real-world environment and real world objects.

The sensor-enabled holster 618 may be an active (powered) or passive (non-powered) sensor that maintains and/or provides state information regarding a weapon or other item normally disposed within the user's 602 sensor-enabled holster 618. The sensor-enabled holster 618 may detect a change in state (presence to absence) and/or an action (removal) relative to the weapon normally disposed within the sensor-enabled holster 618. The detected change in state and/or action may be reported to the portable radio 604 via its short-range transceiver. In some embodiments, the sensor-enabled holster 618 may also detect whether the first responder's hand is resting on the weapon even if it has not yet been removed from the holster and provide such information to portable radio 604. Other possibilities exist as well.

The biometric sensor wristband 620 may be an electronic device for tracking an activity of the user 602 or a health status of the user 602, and may include one or more movement sensors (such as an accelerometer, magnetometer, and/or gyroscope) that may periodically or intermittently provide to the portable radio 604 indications of orientation, direction, steps, acceleration, and/or speed, and indications of health such as one or more of a captured heart rate, a captured breathing rate, and a captured body temperature of the user 602, perhaps accompanying other information. In some embodiments, the biometric sensor wristband 620 may include its own long-range transceiver and may communicate with other communication devices and/or with the infrastructure RAN 652 or vehicular transceiver 636 directly without passing through portable radio 604.

An accelerometer is a device that measures acceleration. Single and multi-axis models are available to detect magnitude and direction of the acceleration as a vector quantity, and may be used to sense orientation, acceleration, vibration shock, and falling. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing.

The heart rate sensor may use electrical contacts with the skin to monitor an electrocardiogramaignal of its wearer, or may use infrared light and imaging device to optically detect a pulse rate of its wearer, among other possibilities. A breathing rate sensor may be integrated within the sensor wristband 620 itself, or disposed separately and communicate with the sensor wristband 620 via a short range wireless or wired connection. The breathing rate sensor may include use of a differential capacitive circuits or capacitive transducers to measure chest displacement and thus breathing rates. In other embodiments, a breathing sensor may monitor a periodicity of mouth and/or nose-exhaled air (e.g., using a humidity sensor, temperature sensor, capnometer or spirometer) to detect a respiration rate. Other possibilities exist as well.

A body temperature sensor may include an electronic digital or analog sensor that measures a skin temperature using, for example, a negative temperature coefficient (NTC) thermistor or a resistive temperature detector (RTD), may include an infrared thermal scanner module, and/or may include an ingestible temperature sensor that transmits an internally measured body temperature via a short range wireless connection, among other possibilities. Although the biometric sensor wristband 620 is shown in FIG. 6 as a bracelet worn around the wrist, in other examples, the biometric sensor wristband 620 may additionally and/or alternatively be worn around another part of the body, or may take a different physical form including an earring, a finger ring, a necklace, a glove, a belt, or some other type of wearable, ingestible, or insertable form factor.

The portable radio 604, RSM video capture device 606, laptop 614, smart glasses 616, sensor-enabled holster 618, and/or biometric sensor wristband 620 may form a personal area network (PAN) via corresponding short-range PAN transceivers, which may be based on a Bluetooth, Zigbee, or other short-range wireless protocol having a transmission range on the order of meters, tens of meters, or hundreds of meters. The portable radio 604 and/or RSM video capture device 606 (or any other electronic device in FIG. 6, for that matter) may each include a location determination device integrated with or separately disposed in the portable radio 604 and/or RSM 606 and/or in respective receivers, transmitters, or transceivers of the portable radio 604 and RSM 606 for determining a location of the portable radio 604 and RSM 606. The location determination device may be, for example, a global positioning system (GPS) receiver or wireless triangulation logic using a wireless receiver or transceiver and a plurality of wireless signals received at the wireless receiver or transceiver from different locations, among other possibilities.

The location determination device may also include an orientation sensor for determining an orientation that the device is facing. Each orientation sensor may include a gyroscope and/or a magnetometer. Other types of orientation sensors could be used as well. The location may then be stored locally or transmitted via the transmitter or transceiver to other communication devices and/or to the infrastructure RAN 652. The vehicle 632 associated with the user 602 may include the mobile communication device 633, the vehicular video camera 634 and/or microphone 135, and the vehicular transceiver 636, all of which may be coupled to one another via a wired and/or wireless vehicle area network (VAN), perhaps along with other sensors physically or communicatively coupled to the vehicle 632. The vehicular transceiver 636 may include a long-range transceiver for directly wirelessly communicating with communication devices such as the portable radio 604, the RSM 606, and the laptop 614 via wireless link(s) 642 and/or with the RAN 652 via wireless link(s) 644. The vehicular transceiver 636 may further include a short-range wireless transceiver or wired transceiver for communicatively coupling between the mobile communication device 633 and/or the vehicular video camera 634 in the VAN.

The mobile communication device 633 may, in some embodiments, include the vehicular transceiver 636 and/or the vehicular video camera 634 integrated therewith, and may operate to store and/or process video and/or audio produced by the video camera 634 and/or transmit the captured video and/or audio as a video and/or audio stream to the portable radio 604, other communication devices, and/or the infrastructure RAN 652 for further analysis. The omni-directional or unidirectional microphone 135, or an array thereof, may be integrated in the video camera 634 and/or at the vehicular computing device 633 (or additionally or alternatively made available at a separate location of the vehicle 632) and communicably coupled to the vehicular computing device 633 and/or vehicular transceiver 636 for capturing audio and storing, processing, and/or transmitting the audio in a same or similar manner as set forth above with respect to the RSM 606.

Although FIG. 6 illustrates the vehicular video camera 634 and microphone 135 as being placed inside the vehicle 632, in other embodiments, one or both of the vehicular video camera 634 and microphone 135 may be placed at visible or hidden locations outside of the vehicle 632, such as within a vehicular grill portion or bumper portion, or on a roof portion, of the vehicle 632. Further, although FIG. 6 illustrates the single speaker 137 as being placed inside of the vehicle 632 and coupled to the vehicular computing device 633, in other embodiments, multiple speakers may be provided inside and/or outside of the vehicle 632 (all addressed simultaneously or individually addressable for outputting separate audio streams), or the single speaker 137 may be placed outside of the vehicle and function as a PA speaker, among other possibilities.

The vehicle 632 may be a human-operable vehicle, or may be a self-driving vehicle operable under control of mobile communication device 633 perhaps in cooperation with video camera 634 (which may include a visible-light camera, an infrared camera, a time-of-flight depth camera, and/or a light detection and ranging (LiDAR) device). Command information and/or status information such as location and speed may be exchanged with the self-driving vehicle via the VAN and/or the PAN (when the PAN is in range of the VAN or via the VAN's infrastructure RAN link). The vehicle 632 and/or transceiver 636, similar to the portable radio 604 and/or respective receivers, transmitters, or transceivers thereof, may include a location (and/or orientation) determination device integrated with or separately disposed in the mobile communication device 633 and/or transceiver 636 for determining (and storing and/or transmitting) a location (and/or orientation) of the vehicle 632.

In some embodiments, instead of a vehicle 632, a land, air, or water-based drone with the same or similar audio and/or video and communications capabilities and the same or similar self-navigating capabilities as set forth above may be disposed, and may similarly communicate with the user's 602 PAN and/or with the infrastructure RAN 652 to support the user 602 in the field. The VAN may communicatively couple with the PAN disclosed above when the VAN and the PAN come within wireless transmission range of one another, perhaps after an authentication takes place there between. In some embodiments, one of the VAN and the PAN may provide infrastructure communications to the other, depending on the situation and the types of devices in the VAN and/or PAN and may provide interoperability and communication links between devices (such as video cameras and sensors) within the VAN and PAN.

Although the RSM 606, the laptop 614, and the vehicle 632 are illustrated in FIG. 6 as providing example video cameras and/or microphones for use in capturing audio and/or video streams, other types of cameras and/or microphones could be used as well, including but not limited to, fixed or pivotable video cameras secured to lamp posts, automated teller machine (ATM) video cameras, other types of body worn cameras such as head-mounted cameras, other types of vehicular cameras such as roof-mounted cameras, or other types of audio and/or video recording devices accessible via a wired or wireless network interface same or similar to that disclosed herein.

Infrastructure RAN 652 is a radio access network that provides for radio communication links to be arranged within the network between a plurality of user terminals. Such user terminals may be portable, mobile, or stationary and may include any one or more of the communication devices illustrated in FIG. 6, among other possibilities. At least one other terminal, e.g. used in conjunction with the communication devices, may be a fixed terminal, e.g. a base station, eNodeB, repeater, and/or access point. Such a RAN typically includes a system infrastructure that generally includes a network of various fixed terminals, which are in direct radio communication with the communication devices. Each of the fixed terminals operating in the RAN 652 may have one or more transceivers which may, for example, serve communication devices in a given region or area, known as a ‘cell’ or ‘site’, by radio frequency (RF) communication. The communication devices that are in direct communication with a particular fixed terminal are said to be served by the fixed terminal. In one example, all radio communications to and from each communication device within the RAN 652 are made via respective serving fixed terminals. Sites of neighboring fixed terminals may be offset from one another and may provide corresponding non-overlapping or partially or fully overlapping RF coverage areas.

Infrastructure RAN 652 may operate according to an industry standard wireless access technology such as, for example, an LTE, LTE-Advance, or 5G technology over which an OMA-POC, a VoIP, an LTE Direct or LTE Device to Device, or a PoIP application may be implemented. Additionally or alternatively, infrastructure RAN 652 may implement a WLAN technology such as Wi-Fi perhaps operating in accordance with an IEEE 802.11 standard (e.g., 802.11a, 802.11b, 802.11g) or such as a WiMAX perhaps operating in accordance with an IEEE 802.16 standard.

Infrastructure RAN 652 may additionally or alternatively operate according to an industry standard LMR wireless access technology such as, for example, the P25 standard defined by the APCO, the TETRA standard defined by the ETSI, the dPMR standard also defined by the ETSI, or the DMR standard also defined by the ETSI. Because these systems generally provide lower throughput than the broadband systems, they are sometimes designated as narrowband RANs. Communications in accordance with any one or more of these protocols or standards, or other protocols or standards, may take place over physical channels in accordance with one or more of a TDMA (time division multiple access), FDMA (frequency divisional multiple access), OFDMA (orthogonal frequency division multiplexing access), or CDMA (code division multiple access) technique.

OMA-POC, in particular and as one example of an infrastructure broadband wireless application, enables familiar PTT and “instant on” features of traditional half duplex communication devices, but uses communication devices operating over modern broadband telecommunications networks. Using OMA-POC, wireless communication devices such as mobile telephones and notebook computers can function as PTT half-duplex communication devices for transmitting and receiving. Other types of PTT models and multimedia call models (MMCMs) are also available. Floor control in an OMA-POC session is generally maintained by a PTT server that controls communications between two or more wireless communication devices. When a user of one of the communication devices keys a PTT button, a request for permission to speak in the OMA-POC session is transmitted from the user's communication device to the PTT server using, for example, a real-time transport protocol (RTP) message.

If no other users are currently speaking in the PoC session, an acceptance message is transmitted back to the user's communication device and the user may then speak into a microphone of the communication device. Using standard compression/decompression (codec) techniques, the user's voice is digitized and transmitted using discrete auditory data packets (e.g., together which form an auditory data stream over time), such as according to RTP and internet protocols (IP), to the PTT server. The PTT server then transmits the auditory data packets to other users of the PoC session (e.g., to other communication devices in the group of communication devices or talkgroup to which the user is subscribed), using for example, one or more of a unicast, point to multipoint, or broadcast communication technique.

Infrastructure narrowband LMR wireless systems, on the other hand, operate in either a conventional or trunked configuration. In either configuration, a plurality of communication devices is partitioned into separate groups of communication devices. In a conventional narrowband system, each communication device in a group is selected to a particular radio channel (frequency or frequency & time slot) for communications associated with that communication device's group. Thus, each group is served by one channel, and multiple groups may share the same single frequency or frequency & time slot (in which case, in some embodiments, group IDs may be present in the group data to distinguish between groups).

In contrast, a trunked radio system and its communication devices use a pool of traffic channels for virtually an unlimited number of groups of communication devices (and which may also be referred to herein as talkgroups). Thus, all groups are served by all channels. The trunked radio system works to take advantage of the probability that not all groups need a traffic channel for communication at the same time. When a member of a group requests a call on a control or rest channel on which all of the communication devices at a site idle awaiting new call notifications, in one embodiment, a call controller assigns a separate traffic channel for the requested group call, and all group members move from the assigned control or rest channel to the assigned traffic channel for the group call. In another embodiment, when a member of a group requests a call on a control or rest channel, the call controller may convert the control or rest channel on which the communication devices were idling to a traffic channel for the call, and instruct all communication devices that are not participating in the new call to move to a newly assigned control or rest channel selected from the pool of available channels. With a given number of channels, a much greater number of groups may be accommodated in a trunked radio system as compared with a conventional radio system.

Group calls may be made between wireless and/or wireline participants in accordance with either a narrowband or a broadband protocol or standard. Group members for group calls may be statically or dynamically defined. That is, in a first example, a user or administrator working on behalf of the user may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., group call) with each of the pre-designated participants in the defined group. In another example, communication devices may dynamically affiliate with a group (and also disassociate with the group) perhaps based on user input, and the switching and/or radio network may track group membership and route new group calls according to the current group membership.

In some instances, broadband and narrowband systems may be interfaced via a middleware system that translates between a narrowband PTT standard protocol (such as P25) and a broadband PTT standard protocol or application (such as OMA-PoC). Such intermediate middleware may include a middleware server for performing the translations and may be disposed in the cloud, disposed in a dedicated on-premises location for a client wishing to use both technologies, or disposed at a public carrier supporting one or both technologies. For example, and with respect to FIG. 6, such a middleware server may be disposed in infrastructure RAN 652 at infrastructure controller 656 or at a separate cloud computing cluster such as cloud compute cluster 662 communicably coupled to controller 656 via internet protocol (IP) network 660, among other possibilities.

The infrastructure RAN 652 is illustrated in FIG. 6 as providing coverage for the portable radio 604, RSM video capture device 606, laptop 614, smart glasses 616, and/or vehicle transceiver 636 via a single fixed terminal 654 coupled to a single infrastructure controller 656 (e.g., a radio controller, call controller, PTT server, zone controller, MME, BSC, MSC, site controller, Push-to-Talk controller, or other network device) and including a dispatch console 658 operated by a dispatcher. In other embodiments, additional fixed terminals and additional controllers may be disposed to support a larger geographic footprint and/or a larger number of mobile devices.

The infrastructure controller 656 illustrated in FIG. 6, or some other back-end infrastructure device or combination of back-end infrastructure devices existing on-premises or in the remote cloud compute cluster 662 accessible via the IP network 660 (such as the Internet), may additionally or alternatively operate as a back-end electronic digital assistant, a back-end audio and/or video processing device, and/or a remote cloud-based storage device consistent with the remainder of this disclosure.

The IP network 660 may comprise one or more routers, switches, LANs, WLANs, WANs, access points, or other network infrastructure, including but not limited to, the public Internet. The cloud compute cluster 662 may be comprised of a plurality of computing devices, such as the one set forth in FIG. 2, one or more of which may be executing none, all, or a portion of an electronic digital assistant service, sequentially or in parallel, across the one or more computing devices. The one or more computing devices comprising the cloud compute cluster 662 may be geographically co-located or may be separated by inches, meters, or miles, and inter-connected via electronic and/or optical interconnects. Although not shown in FIG. 6, one or more proxy servers or load balancing servers may control which one or more computing devices perform any part or all of the electronic digital assistant service.

Database(s) 664 may be accessible via IP network 660 and/or cloud compute cluster 662, and may include databases such as a security database, a long-term video storage database, a historical or forecasted weather database, an offender database perhaps including facial recognition images to match against, a cartographic database of streets and elevations, a traffic database of historical or current traffic conditions, or other types of databases. Databases 664 may further include all or a portion of the databases described herein as being provided at infrastructure controller 656. In some embodiments, the databases 664 may be maintained by third parties (for example, the National Weather Service or a Department of Transportation, respectively). As shown in FIG. 6, the databases 664 are communicatively coupled with the infrastructure RAN 652 to allow the communication devices (for example, the portable radio 604, the RSM video capture device 606, the laptop 614, and the mobile communication device 633) to communicate with and retrieve data from the databases 664 via infrastructure controller 656 and IP network 660. In some embodiments, the databases 664 are commercial cloud-based storage devices. In some embodiments, the databases 664 are housed on suitable on-premises database servers. The databases 664 of FIG. 6 are merely examples. In some embodiments, the system 600 additionally or alternatively includes other databases that store different information. In some embodiments, the databases 664 disclosed herein and/or additional or other databases are integrated with, or internal to, the infrastructure controller 656.

Finally, although FIG. 6 describes a communication system 600 generally as a public safety communication system that includes a user 602 generally described as a police officer and a vehicle 632 generally described as a police car or cruiser, in other embodiments, the communication system 600 may additionally or alternatively be a retail communication system including a user 602 that may be an employee of a retailer and a vehicle 632 that may be a vehicle for use by the user 602 in furtherance of the employee's retail duties (e.g., a shuttle or self-balancing scooter). In other embodiments, the communication system 600 may additionally or alternatively be a warehouse communication system including a user 602 that may be an employee of a warehouse and a vehicle 632 that may be a vehicle for use by the user 602 in furtherance of the employee's retail duties (e.g., a forklift). In still further embodiments, the communication system 600 may additionally or alternatively be a private security communication system including a user 602 that may be an employee of a private security company and a vehicle 632 that may be a vehicle for use by the user 602 in furtherance of the private security employee's duties (e.g., a private security vehicle or motorcycle).

In even further embodiments, the communication system 600 may additionally or alternatively be a medical communication system including a user 602 that may be a doctor or nurse of a hospital and a vehicle 632 that may be a vehicle for use by the user 602 in furtherance of the doctor or nurse's duties (e.g., a medical gurney or ambulance). In still another example embodiment, the communication system 600 may additionally or alternatively be a heavy machinery communication system including a user 602 that may be a miner, driller, or extractor at a mine, oil field, or precious metal or gem field and a vehicle 632 that may be a vehicle for use by the user 602 in furtherance of the miner, driller, or extractor's duties (e.g., an excavator, bulldozer, crane, front loader).

As one other example, the communication system 600 may additionally or alternatively be a transportation logistics communication system including a user 602 that may be a bus driver or semi-truck driver at a school or transportation company and a vehicle 632 that may be a vehicle for use by the user 602 in furtherance of the driver's duties. In the examples of a user 602 being other than a police officer, certain sensors such as the weapon status sensor described above with respect to the police officer user may be replaced or supplemented with other types of sensors, such as one or more sensors that may detect whether a particular retail, warehouse, private security, heavy machinery operator, transportation driver, or other type of user has equipment necessary to perform a particular assigned or to-be-assigned task, whether such equipment is in a workable or sufficient condition, or whether the equipment is sufficient for the area or environment the user is in. Other possibilities and other variations exist as well.

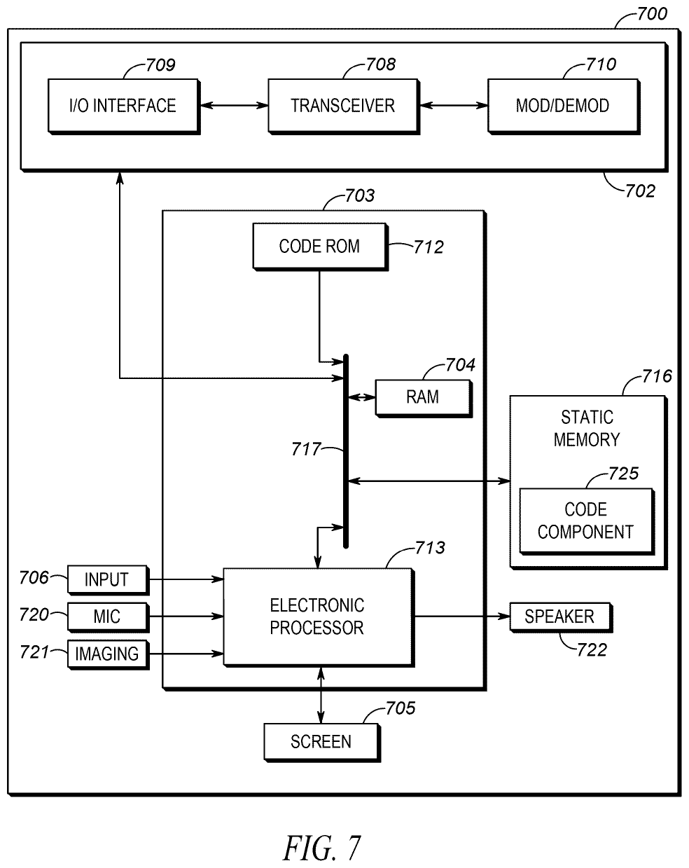

FIG. 7 sets forth a schematic diagram that illustrates a computer device 700 according to some embodiments of the present disclosure. The computer device 700 may be, for example, embodied in the portable radio 604, the RSM video capture device 606, the laptop 614, the mobile communication device 633, the infrastructure controller 656, the dispatch console 658, one or more computing devices in the cloud compute cluster 662, or some other communication device not illustrated in FIG. 6, and/or may be a distributed communication device across two or more of the foregoing (or multiple of a same type of one of the foregoing) and linked via a wired and/or wireless communication link(s). In some embodiments, the computer device 700 (for example, the portable radio 604) may be communicatively coupled to other devices such as the sensor-enabled holster 618 as described above. In such embodiments, the combination of the portable radio 604 and the sensor-enabled holster 118 may be considered a single computer device 700.

While FIG. 7 represents the communication devices described above with respect to FIG. 6, depending on the type of the communication device, the computer device 700 may include fewer or additional components in configurations different from that illustrated in FIG. 7. For example, in some embodiments, computer device 700 acting as the infrastructure controller 656 may not include one or more of the screen 705, input device 706, microphone 720, imaging device 721, and speaker 722. As another example, in some embodiments, the computer device 700 acting as the portable radio 604 or the RSM video capture device 606 may further include a location determination device (for example, a global positioning system (GPS) receiver) as explained above. Other combinations are possible as well.

As shown in FIG. 7, computer device 700 includes a communications unit 702 coupled to a common data and address bus 717 of a processing unit 703. The computer device 700 may also include one or more input devices (e.g., keypad, pointing device, touch-sensitive surface, etc.) 706 and an electronic display screen 705 (which, in some embodiments, may be a touch screen and thus also act as an input device 706), each coupled to be in communication with the processing unit 703.

The microphone 720 may be present for capturing audio from a user and/or other environmental or background audio that is further processed by processing unit 703 in accordance with the remainder of this disclosure and/or is transmitted as voice or audio stream data, or as acoustical environment indications, by communications unit 702 to other portable radios and/or other communication devices. The imaging device 721 may provide video (still or moving images) of an area in a field of view of the computer device 700 for further processing by the processing unit 703 and/or for further transmission by the communications unit 702. A speaker 722 may be present for reproducing audio that is decoded from voice or audio streams of calls received via the communications unit 702 from other portable radios, from digital audio stored at the computer device 700, from other ad-hoc or direct mode devices, and/or from an infrastructure RAN device, or may playback alert tones or other types of pre-recorded audio.

The processing unit 703 may include a code Read Only Memory (ROM) 712 coupled to the common data and address bus 717 for storing data for initializing system components. The processing unit 703 may further include an electronic processor 713 (for example, a microprocessor or another electronic device) coupled, by the common data and address bus 717, to a Random Access Memory (RAM) 704 and a static memory 716.

The communications unit 702 may include one or more wired and/or wireless input/output (I/O) interfaces 709 that are configurable to communicate with other communication devices, such as the portable radio 604, the laptop 614, the wireless RAN 152, and/or the mobile communication device 633. For example, the communications unit 702 may include one or more wireless transceivers 708, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network.

The communications unit 702 may additionally or alternatively include one or more wireline transceivers 708, such as an Ethernet transceiver, a USB transceiver, or similar transceiver configurable to communicate via a twisted pair wire, a coaxial cable, a fiber-optic link, or a similar physical connection to a wireline network. The transceiver 708 is also coupled to a combined modulator/demodulator 710.

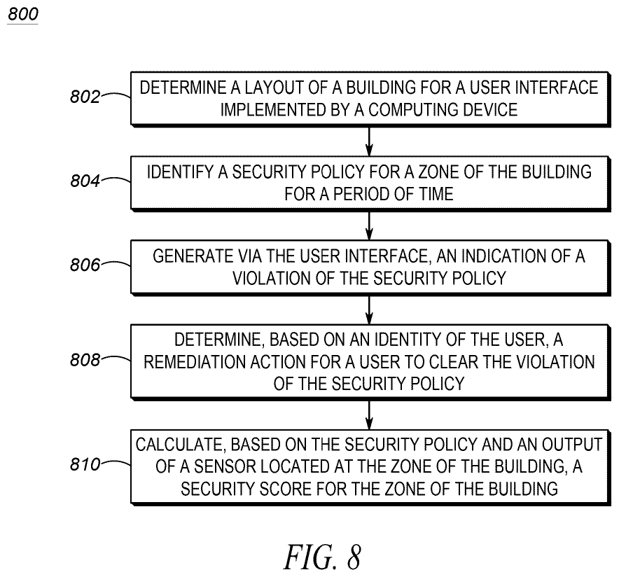

The electronic processor 713 has ports for coupling to the display screen 705, the input device 706, the microphone 720, the imaging device 721, and/or the speaker 722. Static memory 716 may store operating code 725 for the electronic processor 713 that, when executed, performs one or more of the steps set forth in FIG. 8 and accompanying text. The static memory 716 may comprise, for example, a hard-disk drive (HDD), an optical disk drive such as a compact disk (CD) drive or digital versatile disk (DVD) drive, a solid state drive (SSD), a flash memory drive, or a tape drive, and the like.

In some embodiments, the static memory 716 may also store, permanently or temporarily, a threshold level mapping indicating numerical ranges at which auditory output generated by the electronic digital assistant may be lengthened and/or shortened, a database of acronyms and their associated full terms for use in transitioning between one or the other based on a detected acoustic environment, a thesaurus database of words having similar meanings and including a syllable count for use in transitioning between them based on a detected acoustic environment, a 10-code database including the 10-code and the 10-codes associated full term meaning for use in transitioning between one or the other based on a detected acoustic environment, a contraction database setting forth contractions and the words they stand for use in transitioning between one or the other based on a detected acoustic environment, an abbreviation database including the abbreviation and the full word that the abbreviation abbreviates for use in transitioning between one or the other based on a detected acoustic environment, a security policy database such as in FIG. 3, and a security score database such as in FIG. 3.

FIG. 8 illustrates an example flow diagram (e.g., process 800) to improve security of a location, according to certain aspects of the present disclosure. For explanatory purposes, the example process 800 is described herein with reference to one or more of the figures above. Further for explanatory purposes, the blocks of the example process 800 are described herein as occurring in serial, or linearly. However, multiple instances of the example process 800 may occur in parallel, overlapping in time, almost simultaneously, or in a different order from the order illustrated in the process 800. In addition, the blocks of the example process 800 need not be performed in the order shown and/or one or more of the blocks of the example process 800 need not be performed.

At step 802, a layout of a building for a user interface implemented by a computing device may be determined. For example, identifying the security policy comprises determining whether a zone of the building is open or closed and a corresponding access control mechanism is applicable to the zone of the building. For example, a user device comprises the user interface that is indicative of the security policy for the zone of the building. As an example, the user interface comprises a building management dashboard that indicates whether the user has violated or is in compliance with another security policy. At step 804, a security policy for a zone of a the building for a period of time may be identified. For example, identifying the security policy comprises determining whether the zone of the building is open or closed and a corresponding access control mechanism is applicable to the zone of the building.

At step 806, an indication of a violation of the security policy may be generated via the user interface. For example, generating the indication of the violation of the security policy comprises generating a visual indication on the user interface that the zone of the building requires the remediation action. As an example, generating the indication of the violation of the security policy comprises generating a flashing visual indication or color to indicate that the remediation action is required by the security policy. The flashing visual indication or the color varies according to the severity of the security score. According to an aspect, a color scale or visual parameter for the visual indication varies according to a severity of the security score. According to an aspect, the violation of the security policy comprises at least one of a: door in the zone being propped open, malfunctioning sensor or equipment associated with the zone, duration of time, obstructed camera, presence of an unauthorized entrant, number of security reviews not meeting a threshold, or number of security policy updates not meeting the threshold.

At step 808, a remediation action for a user to clear the violation of the security policy may be determined based on an identity of the user. For example, the remediation action that an identity of a user indicates the user is permitted to perform for the zone of the building is determined. For example, the remediation action for the user to clear the violation of the security policy is determined based on a skill attribute of the user and an output of a sensor located at the zone of the building. As an example, determining the remediation action comprises determining at least one of: an urgency of the violation of the security policy, a skill tree or achievement parameter associated with the user, an age or role of the user, or a location of the sensor. For example, determining the remediation action comprises determining a level of the skill attribute. For example, determining the remediation action comprises determining that the output of the sensor indicates a blind spot. According to an aspect, the process 800 comprises prompting, via the user interface, the user to perform the remediation action and to upload a picture of the zone of the building.

At step 810, a security score for the zone of the building may be calculated based on the security policy and the output of the sensor located at the zone. For example, calculating the security score is calculated according to the remediation action. For example, calculating the security score comprises verifying that the remediation action has been taken by the user; and determining a score for the remediation action. For example, calculating the security score comprises determining a rate of decay of a security score of the zone of the building corresponding to the security policy. According to an aspect, the rate of decay is proportional to a severity or a threshold time since a check in of the zone of the building. According to an aspect, the sensor comprises at least one of a: body worn camera, video camera, audio, radio, weapons sensor, or door sensor. For example, the sensor is configured to output sensed data about the zone of the building.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, validate digital certificates, issue tokens, and the like).

In the foregoing specification, specific examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”′, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
determining a layout of a building for a user interface implemented by a computing device;
identifying a security policy for a zone of the building for a period of time;
generating, via the user interface, an indication of a violation of the security policy;
determining, based on an identity of the user, a remediation action for a user to clear the violation of the security policy; and
calculating, based on the security policy and an output of a sensor located at the zone of the building, a security score for the zone of the building.

2. The method of claim 1, wherein identifying the security policy comprises determining whether the zone of the building is open or closed and a corresponding access control mechanism is applicable to the zone of the building.

3. The method of claim 1, wherein generating the indication of the violation of the security policy comprises generating a visual indication on the user interface that the zone of the building requires the remediation action, wherein a color scale or visual parameter for the visual indication varies according to a severity of the security score.

4. The method of claim 1, wherein calculating the security score comprises:
verifying that the remediation action has been taken by the user; and
determining a score for the remediation action.

5. The method of claim 1, wherein calculating the security score comprises determining a rate of decay of a security score of the zone of the building corresponding to the security policy, wherein the rate of decay is proportional to a severity or a threshold time since a check in of the zone of the building.

6. The method of claim 1, further comprising prompting, via the user interface, the user to perform the remediation action.

7. The method of claim 1, wherein the violation of the security policy comprises at least one of a: door in the zone being propped open, malfunctioning sensor or equipment associated with the zone, duration of time, obstructed camera, presence of an unauthorized entrant, number of security reviews not meeting a threshold, or number of security policy updates not meeting the threshold.

8. The method of claim 1, wherein the sensor comprises at least one of a: body worn camera, video camera, audio, radio, or door sensor.

9. A system comprising:
a sensor configured to output sensed data about a zone of a building;
a user device that comprises a user interface indicative of a security policy for the zone of the building; and
a processor communicatively coupled to the sensor and the user device, wherein the processor is configured to:
determine a layout of the zone of the building for output to the user interface;
identify a security policy for the zone of the building for a period of time;
generate, via the user interface, an indication of a violation of the security policy;
determine a remediation action that an identity of a user indicates the user is permitted to perform for the zone of the building;
determine a reward based on a verification via the sensed data from the sensor that the user performed the remediation action to clear the violation of the security policy; and
calculate, based on the reward and the sensed data, a security score for the zone of the building.

10. The system of claim 9, wherein the processor is configured to determine the security policy by determining a rate of decay of a security score of the zone of the building corresponding to the security policy, wherein the rate of decay is proportional to a severity or a threshold time since a check in of the zone of the building.

11. The system of claim 9, wherein the processor is configured to generate the indication of the violation by generating a flashing visual indication or color to indicate that the remediation action is required by the security policy, wherein the flashing visual indication or the color varies according to the severity of the security score.

12. The system of claim 9, wherein the processor is configured to determine the remediation action by determining at least one of: an urgency of the violation of the security policy, a skill tree or achievement parameter associated with the user, an age or role of the user, or a location of the sensor.

13. The system of claim 9, wherein the violation of the security policy comprises at least one of a: door in the zone being propped open, malfunctioning sensor or equipment associated with the zone, duration of time, obstructed camera, presence of an unauthorized entrant, number of security reviews not meeting a threshold, or number of security policy updates not meeting the threshold.

14. The system of claim 9, wherein the user interface comprises a building management dashboard that indicates whether the user has violated or is in compliance with another security policy and wherein the sensor comprises at least one of a: body worn camera, video camera, audio, radio, or door sensor.

15. A computing device comprising:
a processor; and
a computer-readable storage medium having stored thereon program instructions that, when executed by the processor, cause the computing device to perform a set of operations comprising:
determining a layout of a building for a user interface implemented by a computing device;
identifying a security policy for a zone of the building for a period of time;
generating, via the user interface, an indication of a violation of the security policy;
determining, based on a skill attribute of a user and an output of a sensor located at the zone of the building, a remediation action for the user to clear the violation of the security policy; and
calculating, according to the remediation action, a security score for the zone of the building.

16. The computing device of claim 15, wherein the set of operations comprising identifying the security policy comprise determining whether the zone of the building is open or closed and a corresponding access control mechanism is applicable to the zone of the building.

17. The computing device of claim 15, wherein the set of operations comprising determining the remediation action comprise determining a level of the skill attribute.

18. The computing device of claim 15, wherein the set of operations comprising determining the remediation action comprise determining that the output of the sensor indicates a blind spot.

19. The computing device of claim 15, wherein the set of operations further comprise prompting, via the user interface, the user to perform the remediation action and to upload a picture of the zone of the building.

20. The computing device of claim 15, wherein the sensor comprises at least one of a: body worn camera, video camera, audio, radio, or door sensor.
